(19) United States
(12) Patent Application Publication
(10) Pub. No.: US 2022/0389931 A1
(43) Pub. Date: Dec. 8, 2022

(54) CENTRIFUGAL COMPRESSOR

(71) Applicant: MITSUBISHI HEAVY INDUSTRIES COMPRESSOR CORPORATION, Tokyo (JP)

(72) Inventors: Motomu Asahara, Tokyo (JP); Shuichi Yamashita, Tokyo (JP); Akihiro Nakaniwa, Tokyo (JP)

(73) Assignee: MITSUBISHI HEAVY INDUSTRIES COMPRESSOR CORPORATION, Tokyo (JP)

(21) Appl. No.: 17/720,057

(22) Filed: Apr. 13, 2022

(30) Foreign Application Priority Data
Jun. 4, 2021 (JP) 2021-094405

(51) Int. Cl. F04D 17/12; F04D 29/44; F04D 29/30

(52) U.S. Cl. CPC F04D 17/122; F04D 29/441; F04D 29/30; F04D 29/4206

(57) ABSTRACT

A centrifugal compressor includes: an impeller which is allowed to rotate around an axis; a casing which is provided with a return flow path allowing a fluid pressure-fed from the impeller to flow therein; and a return vane which is disposed inside the return flow path, wherein the return vane is provided with an injection port through which a liquid supplied from the outside is injected to the return flow path. Accordingly, power is further reduced while suppressing pressure loss.

### FIELD OF THE INVENTION

The present disclosure relates to a centrifugal compressor. Priority is claimed on Japanese Patent Application No. 2021-94405, filed Jun. 4, 2021, the content of which is incorporated herein by reference.

### DESCRIPTION OF RELATED ART

In order to reduce the power of a centrifugal compressor, a method called intermediate cooling has been proposed as shown in Japanese Patent No. 3873481. The intermediate cooling is a method of reducing power with respect to the same flow rate and pressure ratio by cooling a working fluid in an intermediate flow path of a compression stage in a multi-stage compressor to bring a compression process closer to an isothermal process. Since the required compression work also decreases linearly if the total temperature of the inflowing gas decreases, the power can be reduced by cooling the working gas.

The device according to Japanese Patent No. 3873481 employs a configuration in which a coolant is injected from the outside of a casing to a return flow path on the downstream side of an impeller.

### SUMMARY OF THE INVENTION

However, when the liquid is injected from the outside of the casing into the flow path as described above, it is uneconomical since pressure loss occurs in the working fluid due to the transportation of the injected droplets and it is difficult to uniformly inject the liquid to the working fluid.

The present disclosure has been made to solve the above-described problems and an object thereof is to provide a centrifugal compressor capable of further reducing power while suppressing pressure loss.

In order to solve the above-described problems, a centrifugal compressor according to the present disclosure includes: an impeller which is allowed to rotate around an axis; a casing which is provided with a return flow path allowing a fluid pressure-fed from the impeller to flow therein; and a return vane which is disposed inside the return flow path, wherein the return vane is provided with an injection port through which a liquid supplied from the outside is injected to the return flow path.

According to the present disclosure, it is possible to provide a centrifugal compressor capable of further reducing power while suppressing pressure loss.

### BRIEF DESCRIPTION OF THE DRAWINGS

FIG. 1 is a cross-sectional view showing a configuration of a centrifugal compressor according to an embodiment of the present disclosure.

FIG. 2 is an enlarged cross-sectional view of a main part of the centrifugal compressor according to the embodiment of the present disclosure.

FIG. 3 is a perspective view showing a configuration of a return vane according to the embodiment of the present disclosure.

FIG. 4 is a perspective view showing a modified example of the return vane according to the embodiment of the present disclosure.

### DETAILED DESCRIPTION OF THE INVENTION

(Configuration of Centrifugal Compressor)

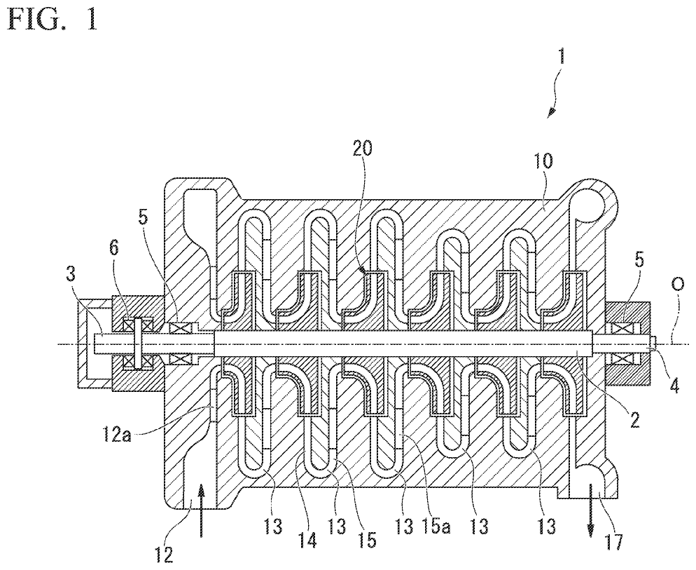

Hereinafter, a centrifugal compressor 1 according to an embodiment of the present disclosure will be described with reference to FIGS. 1 to 3. As shown in FIG. 1, the centrifugal compressor 1 includes a rotating shaft 2 which rotates around an axis 0, a casing 10 which forms a fluid flow path 9 by covering the rotating shaft 2 from the outside, and a plurality of impellers 20 which are provided in the rotating shaft 2.

The rotating shaft 2 has a columnar shape centered on the axis 0. A journal bearing 5 and a thrust bearing 6 are attached to a shaft end 3 on one side of the rotating shaft 2 in the direction of the axis 0. Only the journal bearing 5 is provided at a shaft end 4 on the other side of the rotating shaft 2 in the direction of the axis 0. The journal bearing 5 supports a load in the radial direction of the rotating shaft 2. The thrust bearing 6 supports a load in the direction of the axis 0 of the rotating shaft 2.

The casing 10 has a cylindrical shape centered on the axis 0. The rotating shaft 2 penetrates the inside of the casing 10 along the axis 0. A guide flow path 12 which guides a fluid from the outside toward the impeller 20 is formed on one side of the casing 10 in the direction of the axis 0. Further, an exhaust flow path 17 which discharges a high-pressure fluid compressed inside the casing 10 to the outside is formed on the other side of the casing 10 in the direction of the axis 0. Guide vanes 12a are provided inside the guide flow path 12.

An inner space which communicates the guide flow path 12 and the exhaust flow path 17 with each other and repeats an increase in diameter and a decrease in diameter is formed inside the casing 10. This inner space accommodates the plurality of impellers 20 and constitutes a part of the fluid flow path 9. Additionally, in the description below, the location side of the guide flow path 12 on the fluid flow path 9 is referred to as an upstream side and the location side of the exhaust flow path 17 thereon is referred to as a downstream side.

The fluid flow path 9 includes a diffuser flow path 14, a return bent portion 13, and a return flow path 15. The diffuser flow path 14 is a portion which extends radially outward from the impeller 20. The return bent portion 13 is a portion which is turned by 180° from the radial outer end portion of the diffuser flow path 14 and is directed radially inward. The return flow path 15 is connected to the downstream side of the return bent portion 13. The return flow path 15 extends in the radial direction. Additionally, the return flow path 15 is provided with a plurality of return vanes 15a. The return vanes 15a are arranged at intervals in the circumferential direction.

(Configuration of Return Vane)

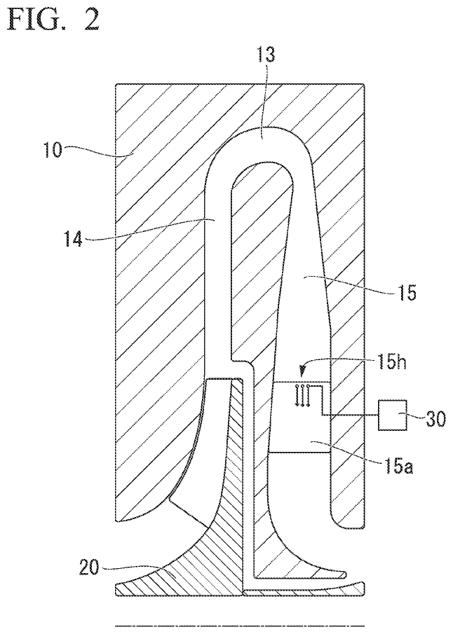

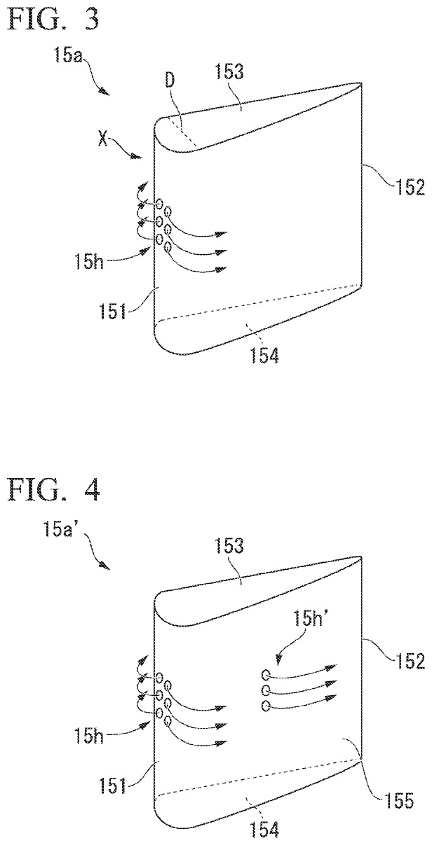

Next, the configuration of the return vane 15a will be described with reference to FIGS. 2 and 3. As shown in FIG. 2, a plurality of injection ports 15h for injecting a liquid are formed on the surface of the return vane 15a. This liquid is pressure-fed from a supply source 30 provided outside the centrifugal compressor 1. The liquid pressure-fed from the supply source 30 is injected from the injection port 15h through a flow path (not shown) formed inside the return vane 15a.

Here, as shown in FIG. 3, the return vane 15a includes a leading edge 151 which is an end edge directed toward the upstream side in the return flow path 15, a trailing edge 152 which is an end edge directed toward the downstream side, and first and second end surfaces 153 and 154 which are connected to the inner wall surface of the return flow path 15. In this embodiment, a plurality of the injection ports 15h are arranged in a region X including the leading edge 151. Additionally, the region X including the leading edge 151 mentioned herein indicates a region on the upstream side of a position D in which the maximum thickness of the return vane 15a having an airfoil cross-section is obtained. That is, the injection ports 15h may not be strictly arranged on the leading edge 151 within this region. In the example of FIG. 3, six injection ports 15h are formed in the region by arranging two rows of the injection ports each including three ones.

Further, these injection ports 15h are arranged only at the center portion of the return vane 15a in the width direction. Specifically, the injection ports 15h are formed in a region separated from the first end surface 153 and the second end surface 154 in the width direction of the return vane 15a. That is, all injection ports 15h are formed at the positions separated from the inner wall surface of the return flow path 15.

Further, the opening direction of the injection port 15h is preferably a direction orthogonal to the flow direction of the fluid containing the swirling component flowing into the return vane 15a. That is, it is preferable that the liquids be injected in a direction away from each other in the two rows of injection ports 15h. Additionally, the opening direction of the injection port 15h is not limited thereto and may be any direction as Long as the Direction does not go Against the Flow of the Working Fluid.

(Operation and Effect)

Next, the operation of the centrifugal compressor 1 will be described. When operating the centrifugal compressor 1, the rotating shaft 2 is first rotated around the axis 0 by a drive source such as an electric motor. The plurality of impellers 20 also rotate together in accordance with the rotation of the rotating shaft 2. As the impeller 20 rotates, a fluid is taken in from the guide flow path 12 into the fluid flow path 9. The impeller 20 applies a centrifugal force to the fluid while the fluid flows through the fluid flow path 9 from the upstream side toward the downstream side, so that the pressure gradually increases. The fluid having a desired pressure is taken out from the exhaust flow path 17 to the outside.

Here, in recent years, a method called intermediate cooling has been proposed in order to reduce the power of a centrifugal compressor. The intermediate cooling is a method of reducing power with respect to the same flow rate and pressure ratio by cooling a working fluid in an intermediate flow path of a compression stage in a multi-stage compressor to bring a compression process closer to an isothermal process. Since the required compression work also decreases linearly if the total temperature of the inflowing gas decreases, the power can be reduced by cooling the working gas.

In order to realize such intermediate cooling, in this embodiment, as described above, the return vane 15a is provided with the injection port 15h for injecting a liquid. The liquid (for example, water) pressure-fed from the external supply source 30 is injected from the injection port 15h. The liquid ejected from the injection port 15h flows toward the downstream side of the return vane 15a along the flow of the working fluid flowing through the return flow path 15. The liquid vaporizes in the middle of this. That is, the liquid melts into the atmosphere of the working fluid. At this time, the working fluid having a high temperature and a high pressure after the compression by the impeller 20 is cooled by the heat of vaporization of the liquid and then the temperature drops.

Accordingly, the compression process by the other impeller 20 on the downstream side can be brought closer to isothermal compression. As a result, it is possible to reduce the power required for driving the centrifugal compressor 1. Further, the energy required for transporting the liquid (droplet) is relatively low in the return flow path 15 since the flow velocity of the working fluid in the return flow path is lower than the other flow paths in the casing 10. Therefore, in the return flow path 15, pressure loss of the working fluid is unlikely to occur even if the liquid is injected. Accordingly, it is possible to more efficiently operate the centrifugal compressor 1.

Further, according to the above-described configuration, the injection port 15h is formed at the center portion of the return vane 15a in the width direction. That is, the injection port 15h is formed at a position separated from the inner wall surface of the return flow path 15. Accordingly, it is possible to reduce the probability that the liquid will adhere to the wall surface. On the other hand, if the liquid adheres to the wall surface, the vaporization of the liquid is not promoted. Accordingly, there is a possibility that pressure loss may occur in the working fluid or erosion may occur on the wall surface. Further, the unvaporized droplets may collide with the impeller on the downstream side to cause erosion. According to the above-described configuration, it is possible to more efficiently and stably operate the centrifugal compressor 1 by reducing the possibility of such an event.

Further, according to the above-described configuration, since the injection port 15h is formed in a region including the leading edge, it is possible to ensure a further sufficient distance until the liquid flows from the injection port 15h to the trailing edge 152 along the flow of the working fluid. As a result, it is possible to more reliably vaporize the liquid injected from the injection port 15h. Thus, it is possible to prevent the liquid from being scattered in the working fluid and suppress the generation of erosion while promoting the cooling of the working fluid.

As described above, the embodiment of the present disclosure has been described. Additionally, it is possible to make various changes and modifications to the above configuration as long as it does not deviate from the gist of the present disclosure. For example, in the above-described embodiment, an example has been described in which the injection port 15h is formed only in a region including the leading edge 151. However, the formation region of the injection port 15h is not limited thereto and the injection port 15h can be formed in another region of the return vane 15a as long as the distance required for vaporization can be ensured. In a broad sense, it is preferable that the injection port 15h be formed in a region on the upstream side of the trailing edge 152.

Further, as indicated by a modified example of FIG. 4, the injection port 15h can be formed in a region including the leading edge 151 and the other injection port 15h′ can be formed on a vane surface 155 of the return vane 15a from the leading edge 151 to the trailing edge 152. Further, even in this case, the injection port 15h′ is preferably formed at the center portion of the return vane 15a in the width direction. In view of the fact that the distance of the vane surface 155 subjected to the vaporization of the liquid is shorter as it is closer to the trailing edge 152, it is preferable that the liquid injection rate of the injection port 15h on the side of the leading edge 151 be larger than that of the injection port 15h′ on the side of the trailing edge 152.

According to the above-described configuration, since the plurality of injection ports 15h and 15h′ are formed in the region from the leading edge to the trailing edge, it is possible to supply more liquid into the return flow path 15. Further, the liquid injection rate of the injection port 15h on the side of the leading edge 151 is larger than that of the injection port 15h′ on the side of the trailing edge 152. In other words, the minimum rate of the liquid is injected from the injection port 15h′ on the side of the trailing edge 152, accordingly it is possible to supply all liquids into the return flow path 15 in a sufficiently vaporized state.

<Appendix>

The centrifugal compressor 1 described in each embodiment is understood, for example, as below.

(1) The centrifugal compressor 1 according to a first aspect includes: the impeller 20 which rotates around the axis 0; the casing 10 which is provided with the return flow path 15 allowing a fluid pressure-fed from the impeller 20 to flow therein; and the return vane 15a which is disposed inside the return flow path 15, and the return vane 15a is provided with the injection port 15h which injects a liquid supplied from the outside into the return flow path 15.

According to the above-described configuration, a liquid is injected from the injection port 15h formed in the return vane 15a to the return flow path 15. Accordingly, it is possible to decrease the temperature of the working fluid flowing through the return flow path 15. That is, the temperature of the working fluid compressed by the upstream impeller 20 to increase the temperature thereof decreases. Accordingly, the compression process by the other impeller 20 on the downstream side can be brought closer to isothermal compression. As a result, it is possible to reduce the power required for driving the centrifugal compressor 1. Further, pressure loss of the working fluid due to the transportation of the liquid (droplet) is unlikely to occur since the flow velocity of the working fluid in the return flow path 15 is lower than the other flow paths in the casing 10. Accordingly, it is possible to more efficiently operate the centrifugal compressor 1.

(2) In the centrifugal compressor 1 according to a second aspect, the injection port 15h may be formed at the center portion of the return vane 15a in the width direction.

According to the above-described configuration, the injection port 15h is formed at the center portion of the return vane 15a in the width direction. That is, the injection port 15h is formed at a position separated from the wall surface of the return flow path 15. Accordingly, it is possible to reduce the probability that the liquid will adhere to the wall surface. On the other hand, if the liquid adheres to the wall surface, the vaporization of the liquid is not promoted. Accordingly, there is a possibility that pressure loss may occur in the working fluid or erosion may occur on the wall surface. According to the above-described configuration, it is possible to more efficiently and stably operate the centrifugal compressor 1 by reducing the possibility of such an event.

(3) In the centrifugal compressor 1 according to a third aspect, the injection port 15h may be formed in a region on the upstream side of the trailing edge 152 corresponding to the end edge on the downstream side of the return vane 15a.

According to the above-described configuration, the injection port 15h is formed in a region on the upstream side of the trailing edge 152. Accordingly, it is possible to ensure a sufficient distance until the liquid flows from the injection port 15h to the trailing edge 152 along the flow of the working fluid. As a result, it is possible to sufficiently vaporize the liquid injected from the injection port 15h. Thus, it is possible to prevent the liquid from being scattered in the working fluid.

(4) In the centrifugal compressor 1 according to a fourth aspect, the injection port 15h may be formed in a region including the leading edge 151 corresponding to the end edge on the upstream side of the return vane 15a.

According to the above-described configuration, since the injection port 15h is formed in a region including the leading edge 151, it is possible to ensure a further sufficient distance until the liquid flows from the injection port 15h to the trailing edge 152 along the flow of the working fluid. As a result, it is possible to more reliably vaporize the liquid injected from the injection port 15h. Thus, it is possible to prevent the liquid from being scattered in the working fluid.

(5) In the centrifugal compressor 1 according to a fifth aspect, the plurality of injection ports 15h and 15h′ may be formed in a region from the leading edge 151 corresponding to the end edge on the upstream side of the return vane 15a to the trailing edge 152 corresponding to the downstream end edge. Further, the liquid injection rate of each the injection port 15h on the side of the leading edge 151 may be larger than that of each the injection port 15h′ on the side of the trailing edge 152.

According to the above-described configuration, since the plurality of injection ports 15h and 15h′ are formed in the region from the leading edge 151 to the trailing edge 152, it is possible to supply more liquid into the return flow path 15. Further, since the liquid injection rate of each the injection port 15h on the side of the leading edge 151 is larger than that of the side of each the injection port 15h′ on the side of the trailing edge 152, it is possible to supply the liquid into the return flow path 15 in a sufficiently vaporized state.

### EXPLANATION OF REFERENCES

1 Centrifugal compressor
2 Rotating shaft
3, 4 Shaft end
5 Journal bearing
6 Thrust bearing
9 Fluid flow path
10 Casing
12 Guide flow path
12a, 12a′ Guide vane
12A Hub side wall surface
12B Shroud side wall surface
13 Return bent portion
14 Diffuser flow path
15 Return flow path
15a, 15a′ Return vane
15h, 15h′ Injection port
17 Exhaust flow path
20 Impeller
30 Supply source
151 Leading edge
152 Trailing edge
153 First end surface
154 Second end surface
155 Vane surface
D Maximum thickness position
O Axis

What is claimed is:

1. A centrifugal compressor comprising:
an impeller which is allowed to rotate around an axis;
a casing which is provided with a return flow path allowing a fluid pressure-fed from the impeller to flow therein; and
a return vane which is disposed inside the return flow path,
wherein the return vane is provided with an injection port through which a liquid supplied from the outside is injected to the return flow path.

2. The centrifugal compressor according to claim 1,
wherein the injection port is formed at a center portion of the return vane in a width direction.

3. The centrifugal compressor according to claim 1,
wherein the injection port is formed in a region on the upstream side of a trailing edge corresponding to an end edge on the downstream side of the return vane.

4. The centrifugal compressor according to claim 1,
wherein the injection port is formed in a region including a leading edge corresponding to an end edge on the upstream side of the return vane.

5. The centrifugal compressor according to claim 1,
wherein a plurality of the injection ports are formed in a region from the leading edge corresponding to the end edge on the upstream side of the return vane to the trailing edge corresponding to the downstream end edge and
wherein the liquid injection rate of a first injection port on the leading edge side is larger than that of a second injection port on the trailing edge side.
